(19) United States
(12) Patent Application Publication
(10) Pub. No.: US 2007/0114983 A1
(43) Pub. Date: May 24, 2007

(54) Switching regulator with hysteretic mode control using zero-ESR output capacitors

(75) Inventors: Matthew Weng, San Ramon, CA (US); Charles Vinn, Milpitas, CA (US)

Correspondence Address: PATENT LAW GROUP LLP, 2635 NORTH FIRST STREET, SUITE 223, SAN JOSE, CA, 95134, US

(73) Assignee: Micrel, Inc.

(21) Appl. No.: 11/284,554

(22) Filed: Nov. 21, 2005

(51) Int. Cl. G05F 1/40

(52) U.S. Cl. 323/282

(57) ABSTRACT

A switching regulator integrated circuit for controlling first and second switches in a hysteretic mode using a zero or very low equivalent series resistance (ESR) capacitor includes an integrated circuit package housing a switching regulator semiconductor chip, a first package lead on the integrated circuit package receiving the regulated output voltage and a second package lead to be coupled to a zero or low ESR capacitor of the LC filter. The first package lead may be connected to a first bond pad of the semiconductor chip using a first bond wire. A second bond wire connects the second package lead to the first package lead, or to the first bond pad, or to a second bond pad electrically shorted to the first bond pad. The capacitor is thus electrically coupled to the regulated output voltage and the second bond wire provides series resistance to the capacitor.

### FIELD OF THE INVENTION

The invention relates to switching regulators and, in particular, to a switching regulator with hysteretic mode control that allows the use of zero-ESR output capacitors.

### DESCRIPTION OF THE RELATED ART

Switch mode power supplies or switching regulators, also referred to as DC to DC converters, are often used to convert an input supply voltage to voltage levels appropriate for the internal circuitry of an integrated circuit. For example, a 5 volts supply voltage provided to an integrated circuit may need to be reduced to 2.8 volts on the IC chip to operate the internal circuitry on the chip.

One control approach for a switching regulator is hysteretic mode control. FIG. 1 is a schematic diagram of a conventional hysteretic mode control switching regulator. A switching regulator 1 includes a switching regulator integrated circuit (IC) 10 with a pair of power switches S1 and S2 integrated thereon. In the present illustration, power switches S1 and S2 are shown as being formed on the integrated circuit chip. It is understood that power switches S1 and S2 can be formed either as internal switches in the switching regulator IC or as external switches to a switching regulator controller integrated circuit. The exact configuration of the power switches is not critical to the implementation of the hysteretic mode control.

Power switches S1 and S2 are turned on and off in order to regulate the output voltage V_{OUT} to be equal to a reference voltage V_{REF}. More specifically, power switches S1 and S2 are alternately turned on and off to generate a switching output voltage V_{SW} which is used to generate a regulated output voltage having a substantially constant magnitude. For instance, the switching output voltage V_{SW} is coupled to an LC filter circuit including an inductor L1 and an output capacitor C_{OUT} to generate voltage V_{OUT} at node 18 having substantially constant magnitude. The output voltage V_{OUT} can then be used to drive a load 20 whereby switching regulator 1 provides the load current I_{LOAD} to maintain the output voltage V_{OUT} at a constant level.

The waveforms of the switching voltage V_{SW}, the inductor current I_{L} and the output voltage V_{OUT} of switching regulator 1 in steady-state operation are shown in FIG. 2. At the beginning of a switching cycle, switch S1 is closed to cause voltage V_{SW} at node 16 to increase to the supply voltage V_{IN}. Current I_{L} flowing through inductor L1 also increases. As the inductor current I_{L} increases, the current through the output capacitor C_{OUT} also increases. Output capacitor C_{OUT} is required to have a finite amount of equivalent series resistance (ESR) as represented by the resistor ESR in dotted box 19 in FIG. 1. Thus, the output voltage V_{OUT} at node 18 increases as a result of the increasing current flowing through resistor ESR.

Voltage V_{OUT} increases until it reaches the upper threshold defined by the hysteretic comparator 14. Specifically, the upper threshold is defined as V_{REF}+ΔV_{hys}, as shown in FIG. 2. When voltage V_{OUT} reaches the upper threshold of V_{REF}+ΔV_{hys}, switch S1 is opened and switch S2 is closed, causing voltage V_{SW} at node 16 to turn around and decrease to the ground voltage. As a result, the current I_{L} flowing through inductor L1 decreases and the current through the output capacitor C_{OUT} also decreases. Output voltage V_{OUT} at node 18 decreases as a result of the decreasing current flowing through resistor ESR.

Voltage V_{OUT} decreases until it reaches the lower threshold defined by the hysteretic comparator 14. Specifically, the lower threshold is defined as V_{REF}−ΔV_{hys}, as shown in FIG. 2. When voltage V_{OUT} reaches the lower threshold of V_{REF}−ΔV_{hys}, switch S2 is opened and switch S1 is closed to start a new switching cycle.

The hysteretic mode control in switching regulator 1 depends on the ESR of the output capacitor to generate the voltage ramp on output voltage V_{OUT}. The voltage ramp is critical to facilitate hysteretic mode control whereby the output voltage V_{OUT} swings between the upper threshold limit and the lower threshold limit. The requirement of an output capacitor with a certain amount of ESR precludes the use of low-cost ceramic output capacitors which have very low ESR. One solution to the problem of using very low ESR capacitors is disclosed in U.S. Pat. No. 6,147,478 to Skelton et al. Skelton et al. describes introducing a separate filter circuit including a resistor and a capacitor to generate a ramp signal for the hysteretic comparator.

An improved method to allow the use of low-ESR or zero-ESR capacitors in a hysteretic mode control switching regulator is desired.

### SUMMARY OF THE INVENTION

According to one embodiment of the present invention, a switching regulator integrated circuit for controlling a first switch and a second switch in a hysteretic mode using a zero or very low ESR capacitor is disclosed. The switching regulator integrated circuit controls the first switch and the second switch to drive a switch output node for generating a switching output voltage where the switch output node is to be coupled to an LC filter circuit to generate a regulated output voltage having a substantially constant magnitude. The switching regulator integrated circuit includes an integrated circuit package housing a switching regulator semiconductor chip including control circuitry formed thereon, a first package lead on the integrated circuit package receiving the regulated output voltage and a second package lead on the integrated circuit package to be coupled to a capacitor of the LC filter where the capacitor has zero or very low equivalent series resistance (ESR). The first package lead may be connected to a first bond pad on the switching regulator semiconductor chip using a first bond wire. A second bond wire connects the second package lead to one of the first package lead, the first bond pad, or a second bond pad electrically shorted to the first bond pad. The capacitor is coupled to the second package lead to be electrically coupled to the regulated output voltage and the second bond wire provides series resistance to the capacitor.

According to another aspect of the present invention, a method in a switching regulator integrated circuit for controlling a first switch and a second switch in a hysteretic mode using a zero or very low ESR capacitor is disclosed. The switching regulator integrated circuit controls the first switch and the second switch to drive a switch output node for generating a switching output voltage where the switch output node is to be coupled to an LC filter circuit to generate a regulated output voltage having a substantially constant magnitude. The method includes housing a switching regulator semiconductor chip in an integrated circuit package where the switching regulator semiconductor chip including control circuitry formed thereon; providing a first package lead on the integrated circuit package; and coupling the regulated output voltage to the first package lead. The method may include connecting the first package lead to a first bond pad on the switching regulator semiconductor chip using a first bond wire.

The method further includes providing a second package lead on the integrated circuit package; coupling a capacitor of the LC filter where the capacitor has zero or very low equivalent series resistance (ESR); and connecting the second package lead to one of the first package lead, the first bond pad, or a second bond pad electrically shorted to the first bond pad using a second bond wire. The capacitor is thereby electrically coupled to the regulated output voltage and the second bond wire provides series resistance to the capacitor.

The present invention is better understood upon consideration of the detailed description below and the accompanying drawings.

### BRIEF DESCRIPTION OF THE DRAWINGS

FIG. 1 is a schematic diagram of a conventional hysteretic mode control switching regulator.

FIG. 2 illustrates waveforms of the switching voltage V_{SW}, the inductor current I_{L} and the output voltage V_{OUT} of the switching regulator of FIG. 1 in steady-state operation.

FIG. 3 is a schematic diagram of a switching regulator integrated circuit illustrating the package connection of the output capacitor according to one embodiment of the present invention.

FIG. 4 is an equivalent circuit diagram of the switching regulator integrated circuit of FIG. 3.

FIG. 5 is a schematic diagram of a switching regulator integrated circuit illustrating the package connection of the output capacitor according to an alternate embodiment of the present invention.

FIG. 6 is an equivalent circuit diagram of the switching regulator integrated circuit of FIG. 5.

FIG. 7 is a schematic diagram of a switching regulator integrated circuit illustrating the package connection of the output capacitor according to a third embodiment of the present invention.

FIG. 8 is a schematic diagram of a switching regulator integrated circuit illustrating the package connection of the output capacitor according to a fourth embodiment of the present invention.

### DETAILED DESCRIPTION OF THE PREFERRED EMBODIMENTS

In accordance with the principles of the present invention, a hysteretic mode control switching regulator enables the use of zero-ESR capacitors as the output capacitor by connecting the output voltage to the output capacitor through a bond wire where the bond wire provides the necessary equivalent resistance to generate the voltage ramp signal for the hysteretic comparator. In this manner, a low cost zero-ESR capacitor can be used in the switching regulator to reduce the overhead cost for building the switching regulator.

In the present description, a zero-ESR capacitor refers to a capacitor with very low or nearly zero equivalent series resistance. Typically, a zero-ESR capacitor has an ESR of less than about 0.05 ohms. A ceramic capacitor is one example of a zero-ESR capacitor. A ceramic capacitor has a typical ESR of a few milliohms.

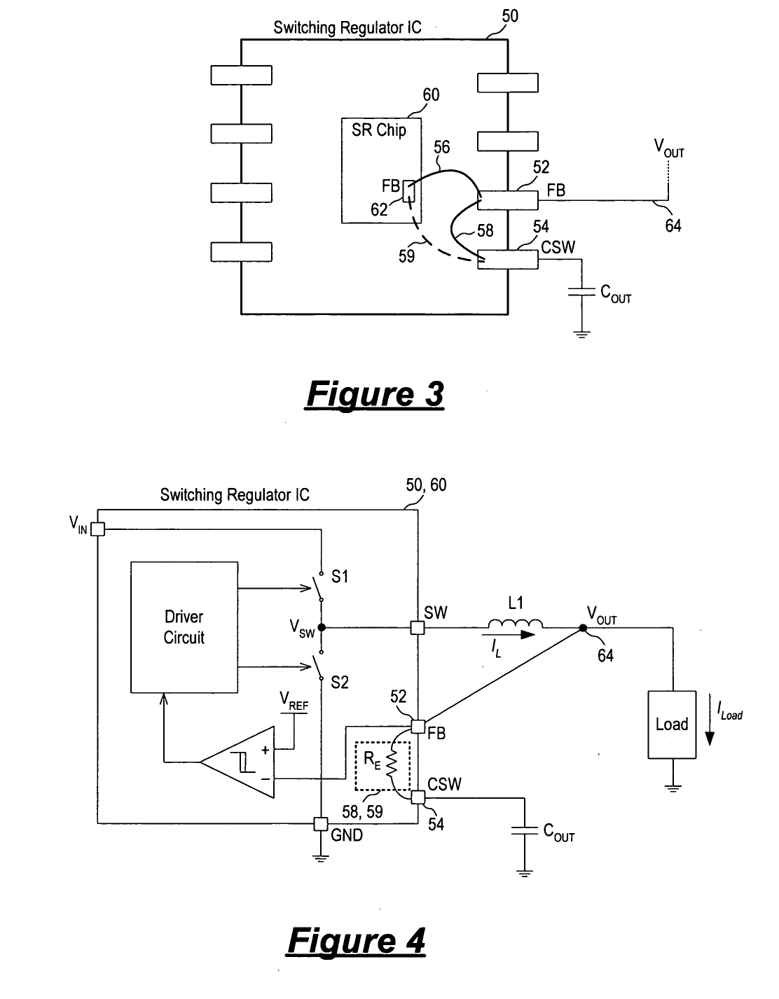

FIG. 3 is a schematic diagram of a switching regulator integrated circuit illustrating the package connection of the output capacitor according to one embodiment of the present invention. FIG. 4 is an equivalent circuit diagram of the switching regulator integrated circuit of FIG. 3.

Referring first to FIG. 3, a switching regulator integrated circuit (IC) 50 includes a switching regulator silicon chip (SR Chip) 60 housed in an integrated circuit package. As is well known in the art, bond pads on the SR chip 60, such as the bond pad 62, are connected via bond wires to respective package leads of the package, such as lead 52. In this manner, electrical connections between signals on SR chip 60 and the outside world are realized.

Furthermore, it is well known that different switching regulator topologies exist, such as relating to the placement of the power switches on or off the SR chip and to the use of internal or external voltage divider to generate the feedback voltage. In general, in all switching regulator designs, the output voltage V_{OUT}, or a voltage related to output voltage V_{OUT}, is fed back to the control circuitry on the SR chip to complete the control loop. In some switching regulator topologies, the output voltage V_{OUT} is fed back directly to the SR chip where the output voltage V_{OUT} may be used directly or may be divided down on-chip to generate the feedback voltage V_{FB} for use in the control loop. In other topologies, the output voltage V_{OUT} is divided down off-chip, that is, external to the switching regulator IC. Then, the divided-down output voltage, referred to as the feedback voltage V_{FB}, is coupled to the SR chip for use in the control loop. In that case, the output voltage V_{OUT} may or may not be fed back to the SR chip. For example, besides the feedback voltage, the output voltage V_{OUT} may be fed back to the SR chip to implement other functions, such as over-voltage protection.

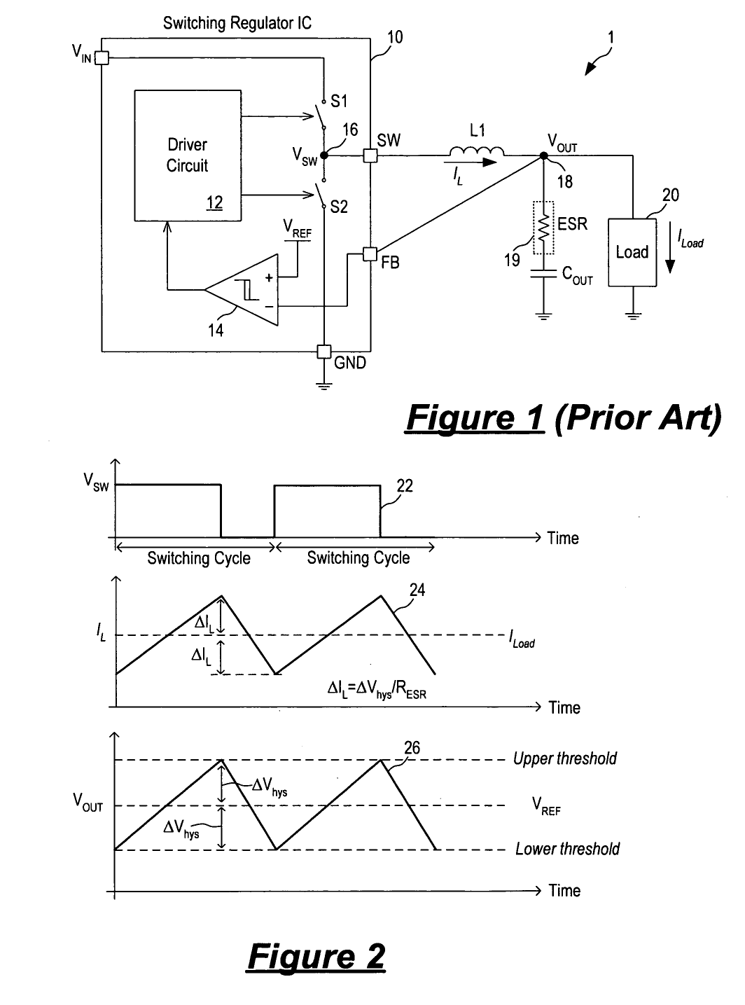

Moreover, a switching regulator IC can be implemented using internal power switches that are integrated on the SR chip or external power switches which are controlled by signals generated by the SR chip. FIG. 1 illustrates an exemplary switching regulator topology where the power switches S1 and S2 are integrated on-chip and where the output voltage V_{OUT} is coupled to the feedback terminal FB of the switching regulator IC to be used by the hysteretic comparator 14 in the control loop. As will be described in more detail below, the method of the present invention to allow the use of zero-ESR output capacitors can be implemented in a hysteretic mode control switching regulator constructed in any topology.

Note that FIG. 1 illustrates a switching regulator IC where the output voltage V_{OUT} is coupled directly to the FB terminal and then to the input terminal of a hysteretic comparator 14. FIG. 1 is illustrative only and the output voltage V_{OUT} may be coupled directly to the hysteretic comparator or the output voltage V_{OUT} may be divided down before being coupled to the comparator. The exact configuration of the control loop of the switching regulator is not critical to the practice of the present invention.

In the embodiment shown in FIGS. 3 and 4, switching regulator IC 50 implements the same topology as the switching regulator IC 10 of FIG. 1. That is, switching regulator 50 uses a pair of on-chip power switches S1 and S2 and the output voltage V_{OUT} is fed back to SR chip 60 directly, without any voltage division, for control loop functions. Thus, as shown in FIG. 3, the output voltage V_{OUT}, on a node 64, is coupled to a package lead 52 being the feedback FB terminal. A bond wire 56 connects the package lead 52 to bond pad 62 on the SR chip 60 which is the feedback node FB of the switching regulator control circuit. The voltage received on the FB node 62 is coupled to a hysteretic comparator to be compared with a reference voltage V_{REF}, as shown in FIG. 4.

In accordance with the present invention, switching regulator IC 50 includes a package lead 54 denoted as the CSW package lead. When an output capacitor C_{OUT} being a zero-ESR capacitor is used with switching regulator IC 50, the output capacitor C_{OUT} is connected to package lead 54. A bond wire 58 inside the IC package connects the output voltage V_{OUT} on package lead 52 to the output capacitor C_{OUT} on package lead 54. In this manner, the resistance of the bond wire 58 substitutes for the ESR of the output capacitor C_{OUT} and a zero-ESR capacitor can be used as the output capacitor of the hysteretic mode control switching regulator. The equivalent circuit of switching regulator IC 50 is shown in FIG. 4 where a resistor R_{E}, connected between the feedback terminal FB and the capacitor terminal CSW, denotes the equivalent resistance provided by bond wire 58. The circuit connection of a zero-ESR capacitor through a bond wire to the output voltage V_{OUT} is eclectically identical to the circuit connection of a capacitor with ESR to the output voltage V_{OUT} as shown in FIG. 1.

The resistance of a bond wire is a function of the bond wire diameter and the length of wire used for the connection between the two package leads. A bond wire of nominal length and nominal diameter can typically provide an equivalent resistance of about 0.05 ohms. In accordance with the present invention where the bond wire is disposed to provide a given serial resistance for the output voltage, a bond wire of a given diameter and a given length to provide about 0.05 ohms of resistance is usually sufficient for most applications.

One advantage of the implementation of the present invention is flexibility to allow the user of the switching regulator IC to use a zero-ESR capacitor or a capacitor with ESR. When a capacitor with ESR is desired to be used, the user will simply connect the output capacitor C_{OUT} to the output voltage and leave package lead 54 unconnected. When a zero-ESR capacitor is to be used, the zero-ESR capacitor will be connected to the CSW package lead 54 where bond wire 58 provides the necessary series resistance between the output voltage V_{OUT} and the output capacitor.

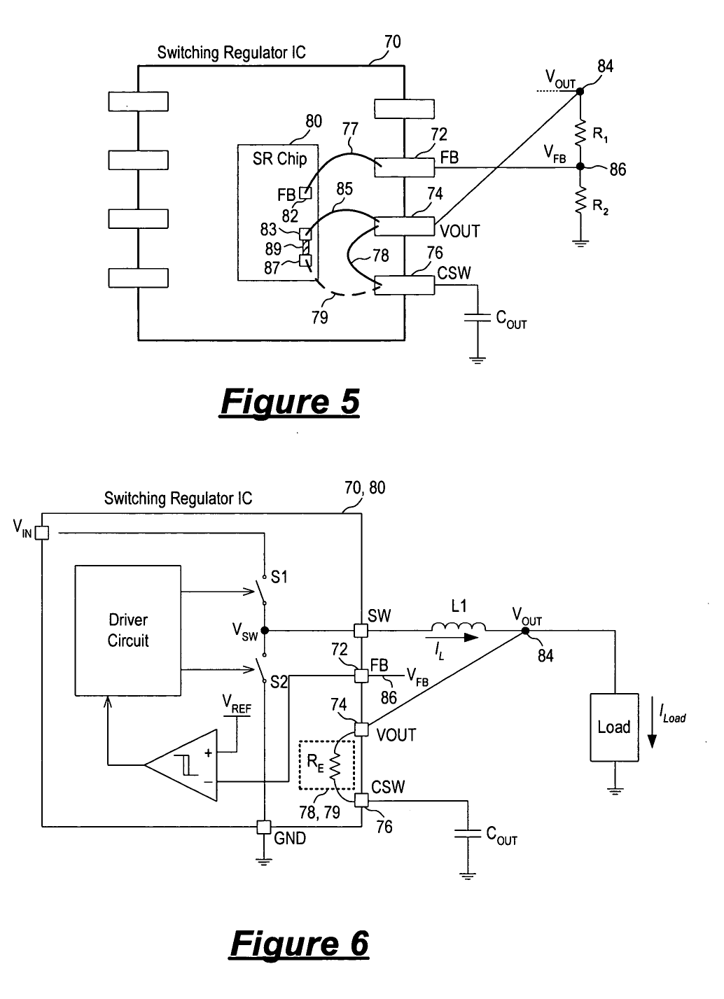

As described above, the method of the present invention can be applied to switching regulator integrated circuit implemented using other topologies. FIG. 5 is a schematic diagram of a switching regulator integrated circuit illustrating the package connection of the output capacitor according to an alternate embodiment of the present invention. FIG. 6 is an equivalent circuit diagram of the switching regulator integrated circuit of FIG. 5.

In the switching regulator topology illustrated in FIGS. 5 and 6, switching regulator integrated circuit (IC) 70 includes on-chip power switches S1 and S2 but uses an external voltage divider network to generate the feedback voltage V_{FB}. Specifically, referring to FIG. 5, a voltage divider including resistors R₁ and R₂ is coupled to the output voltage V_{OUT} node 84. A divided down output voltage V_{OUT} is generated at node 86 and is used as the feedback voltage V_{FB} for the control loop. Thus, feedback voltage V_{FB} on node 86 is coupled to the FB terminal (package lead 72) to be coupled through a bond wire 77 to the feedback node (bond pad 82) of the switching regulator silicon chip 80.

In the present embodiment, the method of the present invention is implemented by introducing one or two package leads to switching regulator IC 70 to introduce a series resistance to the zero-ESR capacitor to be used. Thus, switching regulator IC 70 includes a package lead 74 coupled to receive the output voltage V_{OUT} on node 84 directly. Switching regulator IC 70 also includes a package lead 76 for coupling to an output capacitor. A bond wire 78 connects package lead 76 (output voltage V_{OUT}) to package lead 76 (the output capacitor) where the bond wire 78 provides series resistance to the output capacitor.

Thus, in accordance with the present invention, when a zero-ESR capacitor is to be used with switching regulator IC 70 as the output capacitor, the output voltage V_{OUT} (node 84) is connected to package lead 74 while the zero-ESR capacitor is connected to package lead 76. In this manner, bond wire 78 provides series resistance to the zero-ESR output capacitor C_{OUT}.

In some switching regulator topologies, even when an external voltage divider is used to generate the feedback voltage, the output voltage V_{OUT} is sometimes coupled back to the switching regulator silicon chip (through bond wire 85) to implement other functions. For example, the output voltage V_{OUT} may be coupled back to circuitry on the switching regulator silicon chip to implement over voltage protection operation, as shown in FIG. 5. Thus, in some implementations, package lead 74 receiving the output voltage V_{OUT} is already part of the original switching regulator design and the method of the present invention can be incorporated by simply adding the CSW package lead 78 for the zero-ESR capacitor. As with the case of the switching regulator of FIG. 3, when an output capacitor with ESR is used, the output capacitor can be connected directly to the output voltage and CSW lead 54 can be left connected.

As shown in FIG. 6, bond wire 78 provides an equivalent series resistance, denoted by resistor R_{E}, between the output voltage V_{OUT} and the output capacitor which is a zero-ESR capacitor. The operation of switching regulator IC 50 is the same as in the case where a capacitor with ESR coupled to the output voltage is used.

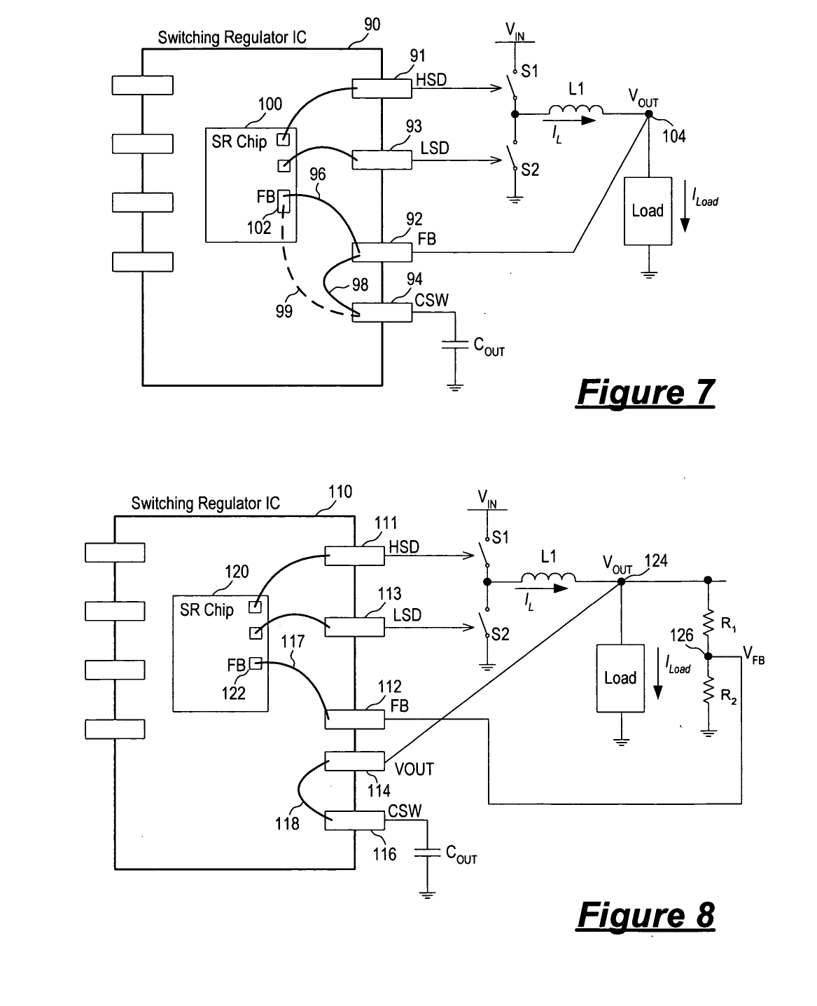

Finally, the method of the present invention can be applied to switching regulator topologies using external power switches. FIG. 7 is a schematic diagram of a switching regulator integrated circuit illustrating the package connection of the output capacitor according to a third embodiment of the present invention. FIG. 8 is a schematic diagram of a switching regulator integrated circuit illustrating the package connection of the output capacitor according to a fourth embodiment of the present invention.

Referring to FIG. 7, a switching regulator integrated circuit 90 includes a switching regulator silicon chip (SR Chip) 100 providing a high side drive signal HSD (lead 91) and a low side drive signal LSD (lead 93) to drive a pair of power switches S1 and S2 external to the package of the switching regulator IC 90. In the embodiment shown in FIG. 7, the output voltage V_{OUT} is directly coupled to feedback terminal (lead 92) to be used in the control loop. A bond wire 96 connects the output voltage V_{OUT} received on the FB lead 92 to a bond pad 102. To facilitate the use of zero-ESR capacitors as the output capacitor, switching regulator IC 90 includes a CSW package lead 94 to which a zero-ESR capacitor can be coupled. A bond wire 98 connects the output voltage on lead 92 to the output capacitor C_{OUT} on lead 94 to provide equivalent series resistance to the zero-ESR output capacitor coupled to lead 94.

Referring to FIG. 8, a switching regulator integrated circuit 110 is implemented in the same manner as switching regulator IC 90 of FIG. 7 except that an external voltage divider of resistors R₁ and R₂ is used to generate a feedback voltage from the output voltage V_{OUT}. As in the switching regulator of FIG. 5, switching regulator 110 includes a VOUT package lead 114 to which the output voltage V_{OUT} (node 124) is coupled and a CSW package lead 116 to which a zero-ESR capacitor is coupled. A bond wire 118 connects the output voltage V_{OUT} (lead 114) to the output capacitor C_{OUT} (lead 116). Bond wire 118 provides equivalent series resistance to the zero-ESR output capacitor coupled to lead 116. VOUT package lead 114 can be added to implement the method of the present invention or the VOUT package lead can be part of the original design of the switching regulator integrated circuit.

In the above descriptions, a bond wire between two package leads is used to introduce an equivalent series resistance to a zero-ESR output capacitor to be coupled to the output voltage V_{OUT} of the switching regulator. However, in other embodiments, the bond wire for introducing equivalent series resistance may be connected between a bond pad on the switching regulator silicon chip and the CSW package lead to which the zero-ESR output capacitor is coupled. More specifically, whenever the output voltage V_{OUT} is connected through a package lead back to a bond pad on the switching regulator silicon chip, it is possible to introduce the equivalent series resistance to the output capacitor by connecting the CSW package lead to a bond pad on the switching regulator silicon chip as long as the bond pad is electrically coupled to the output voltage V_{OUT}. The alternate bond wire connection is thus between a bond pad on the switching regulator silicon die electrically coupled to the output voltage V_{OUT} and the package lead CSW.

The alternate bond wire connection between a bond pad and a package lead is illustrated by dotted lines in FIGS. 3, 5 and 7. Referring to FIG. 3, output voltage V_{OUT} is connected through package lead 52 and bond wire 56 to FB bond pad 62 on the switching regulator chip 60. Thus, instead of using a pin-to-pin bond wire 58, a bond wire 59 connecting the CSW package lead 54 to the FB bond pad 62 can be used to accomplish the same result of introducing equivalent series resistance between the output voltage V_{OUT} and the zero-ESR output capacitor C_{OUT}. Note that in order to accommodate two bond wires on the same bond pad, bond pad 62 needs to be made into a double bond pad with enlarged pad area to receive the two bond wires, as is well known in the art.

Referring to FIG. 5, output voltage V_{OUT} is coupled through package lead 74 and bond wire 85 to a bond pad 83 on switching regulator silicon chip 80. In this embodiment, bond pad 83 is sized for a single bond wire. Thus, to allow CSW package lead 76 to be connected to a bond pad on the silicon chip, a second bond pad 87 is provided. Bond pad 87 is electrically shorted to bond pad 83, such as through a metal line 89, so that bond pad 87 is electrically coupled to the output voltage V_{OUT}. A bond wire 79 is then used to connect the CSW package lead 76 to bond pad 87 on the silicon chip to accomplish the same result of introducing equivalent series resistance between the output voltage V_{OUT} and the zero-ESR output capacitor C_{OUT}.

Referring to FIG. 7, output voltage V_{OUT} is coupled through package lead 92 and bond wire 96 to bond pad 102 on switching regulator silicon chip 100. Thus, instead of using a pin-to-pin bond wire 98, a bond wire 99 connecting the CSW package lead 94 to bond pad 102 can be used to accomplish the same result of introducing equivalent series resistance between the output voltage V_{OUT} and the zero-ESR output capacitor C_{OUT}. In FIG. 7, bond pad 102 is a double bond pad with enlarged pad area to receive the two bond wires.

Of course, in cases where the output voltage V_{OUT} is not coupled back to the switching regulator silicon chip, a pin-to-pin bond wire has to be used to introduce the equivalent series resistance between the output voltage V_{OUT} (on lead 114) and the CSW package pin 116, as shown in FIG. 8.

In sum, when the output voltage V_{OUT} is electrically coupled to the switching regulator silicon chip, the bond wire connected to the CSW package lead for providing equivalent series resistance to the output capacitor can be connected to the package lead where the output voltage V_{OUT} is fed back (pin-to-pin connection) or to a bond pad on the silicon chip (pin-to-pad connection). The bond pad for the ESR bond wire can be the same bond pad to which the output voltage V_{OUT} is connected, provided that the bond pad is sized to accommodate two bond wires. The bond pad can also be a separate bond pad that is electrically shorted to the bond pad receiving the output voltage V_{OUT}.

The above detailed descriptions are provided to illustrate specific embodiments of the present invention and are not intended to be limiting. Numerous modifications and variations within the scope of the present invention are possible. The present invention is defined by the appended claims.

We claim:

1. A switching regulator integrated circuit for controlling a first switch and a second switch in a hysteretic mode to drive a switch output node for generating a switching output voltage, the switch output node to be coupled to an LC filter circuit to generate a regulated output voltage having a substantially constant magnitude, the switching regulator integrated circuit comprising:
an integrated circuit package housing a switching regulator semiconductor chip comprising control circuitry formed thereon;
a first package lead on the integrated circuit package receiving the regulated output voltage;
a second package lead on the integrated circuit package to be coupled to a capacitor of the LC filter, the capacitor having zero or very low equivalent series resistance (ESR);
a first bond wire connecting the first package lead to a first bond pad on the switching regulator semiconductor chip; and
a second bond wire connecting the second package lead to one of the first package lead, the first bond pad, or a second bond pad electrically shorted to the first bond pad,
wherein the capacitor is coupled to the second package lead to be electrically coupled to the regulated output voltage and the second bond wire provides series resistance to the capacitor.

2. The switching regulator integrated circuit of claim 1, wherein the regulated output voltage is coupled through the first bond pad to control circuitry on the switching regulator semiconductor chip.

3. The switching regulator integrated circuit of claim 1, further comprising a third package lead on the integrated circuit package receiving a feedback voltage, the feedback voltage being indicative of the regulated output voltage, the third package lead being connected to a third bond pad on the switching regulator semiconductor chip through a third bond wire.

4. The switching regulator integrated circuit of claim 3, wherein the feedback voltage comprises a divided down voltage of the regulated output voltage.

5. The switching regulator integrated circuit of claim 1, wherein the capacitor having zero or very low equivalent series resistance comprises a capacitor having an equivalent series resistance of 0.05 ohms or less.

6. The switching regulator integrated circuit of claim 1, wherein when the second bond wire is connected to the first bond pad, the first bond pad comprises an enlarged bond pad for accommodating the first and second bond wires.

7. A switching regulator integrated circuit for controlling a first switch and a second switch in a hysteretic mode to drive a switch output node for generating a switching output voltage, the switch output node to be coupled to an LC filter circuit to generate a regulated output voltage having a substantially constant magnitude, the switching regulator integrated circuit comprising:
an integrated circuit package housing a switching regulator semiconductor chip comprising control circuitry formed thereon;
a first package lead on the integrated circuit package receiving the regulated output voltage;
a second package lead on the integrated circuit package to be coupled to a capacitor of the LC filter, the capacitor having zero or very low equivalent series resistance (ESR); and
a first bond wire connecting the first package lead to the second package lead,
wherein the capacitor is coupled to the second package lead to be electrically coupled to the regulated output voltage and the first bond wire provides series resistance to the capacitor.

8. The switching regulator integrated circuit of claim 7, further comprising a second bond wire connecting the first package lead to a first bond pad on the switching regulator semiconductor chip, wherein the regulated output voltage is coupled through the first bond pad to control circuitry on the switching regulator semiconductor chip.

9. The switching regulator integrated circuit of claim 7, further comprising a third package lead on the integrated circuit package receiving a feedback voltage, the feedback voltage being indicative of the regulated output voltage, the third package lead being connected to a second bond pad on the switching regulator semiconductor chip through a third bond wire.

10. The switching regulator integrated circuit of claim 9, wherein the feedback voltage comprises a divided down voltage of the regulated output voltage.

11. The switching regulator integrated circuit of claim 7, wherein the capacitor having zero or very low equivalent series resistance comprises a capacitor having an equivalent series resistance of 0.05 ohms or less.

12. A method in a switching regulator for controlling a first switch and a second switch in a hysteretic mode to drive a switch output node for generating a switching output voltage, the switch output node to be coupled to an LC filter circuit to generate a regulated output voltage having a substantially constant magnitude, the method comprising:
housing a switching regulator semiconductor chip in an integrated circuit package, the switching regulator semiconductor chip comprising control circuitry formed thereon;
providing a first package lead on the integrated circuit package;
coupling the regulated output voltage to the first package lead;
connecting the first package lead to a first bond pad on the switching regulator semiconductor chip using a first bond wire;
providing a second package lead on the integrated circuit package;
coupling a capacitor of the LC filter to the second package lead, the capacitor having zero or very low equivalent series resistance (ESR); and
connecting the second package lead to one of the first package lead, the first bond pad, or a second bond pad electrically shorted to the first bond pad using a second bond wire, the capacitor thereby being electrically coupled to the regulated output voltage and the second bond wire provides series resistance to the capacitor.

13. The method of claim 12, further comprising:
providing a third package lead on the integrated circuit package;
coupling a feedback voltage to the third package lead, the feedback voltage being indicative of the regulated output voltage; and
connecting the third package lead to a third bond pad on the switching regulator semiconductor chip using a third bond wire.

14. The method of claim 13, wherein the feedback voltage comprises a divided down voltage of the regulated output voltage.

15. The method of claim 12, wherein the capacitor having zero or very low equivalent series resistance comprises a capacitor having an equivalent series resistance of 0.05 ohms or less.

16. The method of claim 12, wherein when the second bond wire is connected to the first bond pad, the first bond pad comprises an enlarged bond pad for accommodating the first and second bond wires.

17. A method in a switching regulator for controlling a first switch and a second switch in a hysteretic mode to drive a switch output node for generating a switching output voltage, the switch output node to be coupled to an LC filter circuit to generate a regulated output voltage having a substantially constant magnitude, the method comprising:
housing a switching regulator semiconductor chip in an integrated circuit package, the switching regulator semiconductor chip comprising control circuitry formed thereon;
providing a first package lead on the integrated circuit package;
coupling the regulated output voltage to the first package lead;
providing a second package lead on the integrated circuit package;
coupling a capacitor of the LC filter to the second package lead, the capacitor having zero or very low equivalent series resistance (ESR); and
connecting the first package lead to the second package lead using a first bond wire, the capacitor thereby being electrically coupled to the regulated output voltage and the first bond wire provides series resistance to the capacitor.

18. The method of claim 17, further comprising connecting the first package lead to a first bond pad on the switching regulator semiconductor chip using a second bond wire, wherein the regulated output voltage is coupled through the first bond pad to control circuitry on the switching regulator semiconductor chip.

19. The method of claim 17, further comprising:
providing a third package lead on the integrated circuit package;
coupling a feedback voltage to the third package lead, the feedback voltage being indicative of the regulated output voltage; and
connecting the third package lead to a second bond pad on the switching regulator semiconductor chip using a third bond wire.

20. The method of claim 19, wherein the feedback voltage comprises a divided down voltage of the regulated output voltage.

21. The method of claim 17, wherein the capacitor having zero or very low equivalent series resistance comprises a capacitor having an equivalent series resistance of 0.05 ohms or less.
